(19) United States
(12) Patent Application Publication
(10) Pub. No.: US 2024/0349388 A1
(43) Pub. Date: Oct. 17, 2024

(54) COMMUNICATION APPARATUS AND COMMUNICATION METHOD

(71) Applicants: DENSO CORPORATION, Kariya-city (JP); TOYOTA JIDOSHA KABUSHIKI KAISHA, Toyota-shi (JP)

(72) Inventors: Haruhiko Sogabe, Kariya-city (JP); Daiki Maemoto, Kariya-city (JP); Hideaki Takahashi, Kariya-city (JP)

(21) Appl. No.: 18/752,233

(22) Filed: Jun. 24, 2024

Related U.S. Application Data
(63) Continuation of application No. PCT/JP2023/003905, filed on Feb. 7, 2023.

(30) Foreign Application Priority Data
Feb. 9, 2022 (JP) 2022-019075

(51) Int. Cl. H04W 76/27; H04W 72/044

(52) U.S. Cl. CPC H04W 76/27; H04W 72/044

(57) ABSTRACT

A communication apparatus that is a second communication apparatus having a communication capability reduced as compared with a first communication apparatus having a designated communication capability, the communication apparatus includes: a controller configured to perform a random access procedure using a specific initial BWP for the second communication apparatus, which is a bandwidth part (BWP) that is a part of a bandwidth of a cell of a base station in a radio resource control (RRC) idle state or an RRC inactive state. The controller is configured to switch the specific initial BWP to an initial BWP in which a CD-SSB is present, when the random access procedure has failed, in a case where no cell defining-synchronization signal block and physical broadcast channel block (CD-SSB) is present on the specific initial BWP.

### CROSS-REFERENCE TO RELATED APPLICATIONS

The present application is a continuation application of international Patent Application No. PCT/JP2023/003905, filed on Feb. 7, 2023, which designated the U.S., and claims the benefit of priority of Japanese Patent Application No. 2022-019075, filed on Feb. 9, 2022, the entire contents of which are incorporated herein by reference.

### TECHNICAL FIELD

The present disclosure relates to a communication apparatus, and a communication method.

### BACKGROUND ART

In recent years, in the 3rd generation partnership project (3GPP) (registered trademark; the same applies hereinafter), it has been studied to introduce a second communication apparatus having a lower communication capability than a general communication apparatus (hereinafter, appropriate referred to as a first communication apparatus) into a 5G system. The second communication apparatus is a communication apparatus having middle-range performance and price for Internet of things (IoT), and for example, a maximum bandwidth of a bandwidth part (BWP) used for radio communication is configured to be narrower or the number of receivers is smaller as compared with the first communication apparatus.

Here, regarding the introduction of the second communication apparatus into the mobile communication system of the 3GPP, it has been agreed that an initial BWP (hereinafter, appropriately referred to as a specific initial BWP) for the second communication apparatus is configured independently of an initial BWP (hereinafter, appropriately referred to as a default initial BWP) for the first communication apparatus.

It has been agreed that, when the second communication apparatus is in a radio resource control (RRC) idle state or an RRC inactive state, the second communication apparatus monitors paging on an initial BWP where a cell defining-synchronization signal block and physical broadcast channel block (CD-SSB) is present, and performs cell (re)selection and measurement in the CD-SSB. In addition, it has been agreed that, in a case where a specific initial BWP is configured, the second communication apparatus performs a random access procedure on the specific initial BWP (see, for example, Non Patent Literature 1).

### CITATION LIST

### Non Patent Literature

Non Patent Literature 1: 3GPP Contribution: R2-2201662

### SUMMARY OF INVENTION

A communication apparatus according to a first aspect is a second communication apparatus having a communication capability reduced as compared with a first communication apparatus having a designated communication capability. The communication apparatus includes: a controller configured to perform a random access procedure using a specific initial BWP for the second communication apparatus, which is a bandwidth part (BWP) that is a part of a bandwidth of a cell of a base station in a radio resource control (RRC) idle state or an RRC inactive state. The controller is configured to switch the specific initial BWP to an initial BWP in which a CD-SSB is present, when the random access procedure has failed, in a case where no cell defining-synchronization signal block and physical broadcast channel block (CD-SSB) is present on the specific initial BWP.

A communication apparatus according to a second aspect is a second communication apparatus having a communication capability reduced as compared with a first communication apparatus having a designated communication capability. The communication apparatus includes: a controller configured to perform a random access procedure using a specific initial BWP for the second communication apparatus, which is a bandwidth part (BWP) that is a part of a bandwidth of a cell of a base station in a radio resource control (RRC) idle state or an RRC inactive state; and a transmitter configured to transmit a request message for establishing an RRC connection or resuming the RRC connection to the base station in the random access procedure. The controller is configured to switch the specific initial BWP to an initial BWP when an RRC rejection message is received as a response to the request message from the base station in a case where no cell defining-synchronization signal block and physical broadcast channel block (CD-SSB) is present on the specific initial BWP.

A communication apparatus according to a third aspect is a second communication apparatus having a communication capability reduced as compared with a first communication apparatus having a designated communication capability. The communication apparatus includes: a controller configured to perform a random access procedure using a specific initial BWP for the second communication apparatus, which is a bandwidth part (BWP) that is a part of a bandwidth of a cell of a base station in a radio resource control (RRC) idle state or an RRC inactive state; and a transmitter configured to transmit a request message for establishing an RRC connection or resuming the RRC connection to the base station in the random access procedure. The controller is configured to switch the specific initial BWP to an initial BWP, when a response to the request message is not received from the base station within a designated time after the request message is transmitted, in a case where no cell defining-synchronization signal block and physical broadcast channel block (CD-SSB) is present on the specific initial BWP.

A communication apparatus according to a four aspect is a second communication apparatus having a communication capability reduced as compared with a first communication apparatus having a designated communication capability. The communication apparatus includes: a controller configured to perform a random access procedure using a specific initial BWP for the second communication apparatus, which is a bandwidth part (BWP) that is a part of a bandwidth of a cell of a base station in a radio resource control (RRC) idle state or an RRC inactive state; and a transmitter configured to transmit a request message for resuming an RRC connection to the base station in the random access procedure. The controller is configured to switch the specific initial BWP to an initial BWP, when an integrity check failure indication indicating a failure of an integrity check is transmitted to an RRC layer from a lower layer within a designated time after the request message is received, in a case where no cell defining-synchronization signal block and physical broadcast channel block (CD-SSB) is present on the specific initial BWP.

A communication method executed by a communication apparatus according to a five aspect is a second communication apparatus having a communication capability reduced as compared with a first communication apparatus having a designated communication capability. The communication method includes the steps of: performing a random access procedure using a specific initial BWP for the second communication apparatus, which is a bandwidth part (BWP) that is a part of a bandwidth of a cell of a base station in a radio resource control (RRC) idle state or an RRC inactive state; and switching the specific initial BWP to an initial BWP in which a CD-SSB is present, when the random access procedure has failed, in a case where no cell defining-synchronization signal block and physical broadcast channel block (CD-SSB) is present on the specific initial BWP.

### BRIEF DESCRIPTION OF DRAWINGS

Objects, features, advantages, and the like of the present disclosure will become more apparent from the following detailed description with reference to the accompanying drawings.

FIG. 1 is a diagram illustrating a configuration of a mobile communication system according to an embodiment.

FIG. 2 is a diagram illustrating a configuration example of a protocol stack according to the embodiment.

FIG. 3 is a diagram illustrating an example of a relationship between an SSB and an initial BWP according to the embodiment.

FIG. 4 is a sequence diagram for explaining an operation example of a UE in an RRC idle state or an RRC inactive state.

FIG. 5 is a diagram illustrating a configuration of a UE according the embodiment.

FIG. 6 is a diagram illustrating a configuration of a base station according to the embodiment.

FIG. 7 is a flowchart for explaining an operation example of the UE according to the embodiment.

FIG. 8 is a diagram (part 1) for explaining the operation example of the UE according to the embodiment.

FIG. 9 is a diagram (part 2) for explaining the operation example of the UE according to the embodiment.

FIG. 10 is a diagram (part 3) for explaining the operation example of the UE according to the embodiment.

FIG. 11 is a diagram (part 4) for explaining the operation example of the UE according to the embodiment.

FIG. 12 is a diagram (part 5) for explaining the operation example of the UE according to the embodiment.

FIG. 13 is a diagram (part 6) for explaining the operation example of the UE according to the embodiment.

FIG. 14 is a diagram for explaining an operation example of a UE according to another embodiment.

### DESCRIPTION OF EMBODIMENTS

A mobile communication system according to an embodiment will be described with reference to the drawings. In the description of the drawings, the same or similar parts are denoted by the same or similar reference numerals.

It is assumed that a second communication apparatus in an RRC idle state or an RRC inactive state attempts to establish an RRC connection according to, for example, a random access procedure, on a specific initial BWP in which no CD-SSB is present, and the establishment of the RRC connection fails. In this case, since no CD-SSB is present on the specific initial BWP, the second communication apparatus may not be able to execute paging monitoring, cell (re)selection, and measurement, and may not be able to execute appropriate communication.

Therefore, an object of the present disclosure is to provide a communication apparatus and a communication method capable of executing appropriate communication even when no CD-SSB is present on the initial BWP for the second communication apparatus.

### (System Configuration)

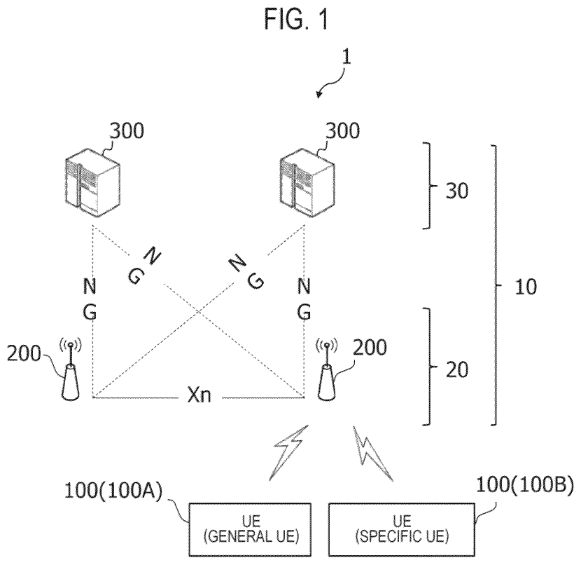

First, a configuration of a mobile communication system 1 according to the present embodiment will be described with reference to FIG. 1. The mobile communication system 1 is, for example, a system conforming to a technical specification (TS) of 3GPP. Hereinafter, as the mobile communication system 1, a 5th generation system (5G system) of the 3GPP standard, that is, a mobile communication system based on new radio (NR) radio access will be described as an example.

The mobile communication system 1 includes a network 10 and a user equipment (UE) 100 that communicates with the network 10. The network 10 includes a next generation radio access network (NG-RAN) 20, which is a 5G radio access network, and a 5G core network (5GC) 30.

The UE 100 is an example of a communication apparatus. The UE 100 may be a mobile radio communication apparatus. The UE 100 may be a communication apparatus that communicates via a base station 200. The UE 100 may be an apparatus used by a user. The UE 100 is, for example, a mobile apparatus such as a mobile phone terminal such as a smartphone, a tablet terminal, a notebook PC, a communication module, or a communication card. The UE 100 may be a vehicle (for example, a car, a train, or the like) or an apparatus (for example, a vehicle UE) provided in the vehicle. The UE 100 may be a transport body other than the vehicle (for example, a ship, an airplane, or the like) or an apparatus (for example, an aerial UE) provided in the transport body. The UE 100 may be a sensor or an apparatus provided in the sensor. Note that the UE 100 may be referred to as another term such as a terminal, a terminal apparatus, a mobile station, a mobile terminal, a mobile apparatus, a mobile unit, a subscriber station, a subscriber terminal, a subscriber apparatus, a subscriber unit, a wireless station, a wireless terminal, a wireless apparatus, a wireless unit, a remote station, a remote terminal, a remote apparatus, or a remote unit. In addition, the UE 100 is an example of a terminal, and the terminal may include a factory device or the like.

In the present embodiment, as the UE 100 of NR, two types of UEs are assumed, that is, a general user equipment (general UE) 100A and a specific UE 100B having a lower communication capability than the general UE 100A. The general UE 100A may have a designated communication capability. The specific UE 100B may have a communication capability lower than the designated communication capability. The designated communication capability may be a capability based on at least one of a maximum bandwidth used for radio communication and the number of receivers. The designated communication capability may be a capability defined by a maximum bandwidth used for radio communication and/or the number of receivers. The specific UE 100B may be an apparatus having a narrower maximum bandwidth and/or a smaller number of receivers than the general UE 100A. The general UE 100A is a first communication apparatus, and the specific UE 100B is a second communication apparatus. The general UE 100A may be referred to as a general communication apparatus, and the specific UE 100B may be referred to as a specific communication apparatus. In addition, the specific UE 100B may be referred to as a RedCap user equipment (RedCap UE). The general UE 100A has advanced communication capabilities such as enhanced mobile broadband (eMB and ultra-reliable and low latency communications (URLLC), which are characteristics of NR. Therefore, the general UE 100A has a higher communication capability than the specific UE 100n. The general UE 100A may be referred to as a non-RedCap UE. The general UE 100A may be an existing UE, that is, a UE (a so-called legacy UE) prior to Release 16.

The specific UE 100B is a UE with apparatus cost and complexity reduced as compared with the general UE 100A. The specific UE 100B is a UE 100 with performance and price in the middle range for IoT, and for example, configured to be narrower in the maximum bandwidth used for radio communication or smaller in the number of receivers than that of the general UE 100A. Note that the receiver may be referred to as a reception branch. The specific UE 100B may be referred to as a reduced capability NR device.

Specifically, the specific UE 100B may be able to communicate at a communication speed equal to or higher than a communication speed defined by a low power wide area (LPWA) standard, for example, long term evolution UE category (LTE Cat.) 1/1 bis, LTE Cat.M1 (LTE-M), or LTE Cat.NB1 (NB-IoT). The specific UE 100B may be able to communicate in a bandwidth equal to or larger than a bandwidth defined by the LPWA standard. The specific UE 100B may have a restricted bandwidth used for communication as compared with a UE of Rel-15 or Rel-16. For example, regarding a frequency range 1 (FR1), the maximum bandwidth (also referred to as the UE maximum bandwidth) supported by the specific UE 100B may be 20 MHz. In addition, regarding a frequency range 2 (FR2), the maximum bandwidth supported by the specific UE 100B may be 100 MHz. The specific UE 100B may have only one receiver that receives a radio signal. The specific UE 100B may be, for example, a wearable apparatus, a sensor apparatus, or the like.

The NG-RAN 20 includes a plurality of base stations 200. Each of the base stations 200 manages at least one cell. A cell forms a minimum unit of a communication area. One cell belongs to one frequency (carrier frequency). The term “cell” may represent a radio communication resource, and may also represent a communication target of the UE 100. Each base station 200 can perform radio communication with the UE 100 existing in its own cell. The base station 200 communicates with the UE 100 by using a protocol stack of the RAN. The details of the protocol stack will be described below. Further, the base station 200 is connected to another base station 200 (which may also be referred to as a neighboring base station) via an Xn interface. The base station 200 communicates with the neighboring base station via the Xn interface. In addition, the base station 200 provides NR user plane and control plane protocol terminations towards the UE 100 and is connected to a 5GC 30 via an NG interface. Such a base station 200 of NR may be referred to as a gNodeB (gNB).

The 5GC 30 includes a core network apparatus 300. The core network apparatus 300 includes, for example, an access and mobility management function (AMF) and/or a user plane function (UPF). The AMF performs mobility management of the UE 100. The UPF provides a function specialized for U-plane processing. The AMF and the UPF are connected to the base station 200 via the NG interface.

### (Configuration Example of Protocol Stack)

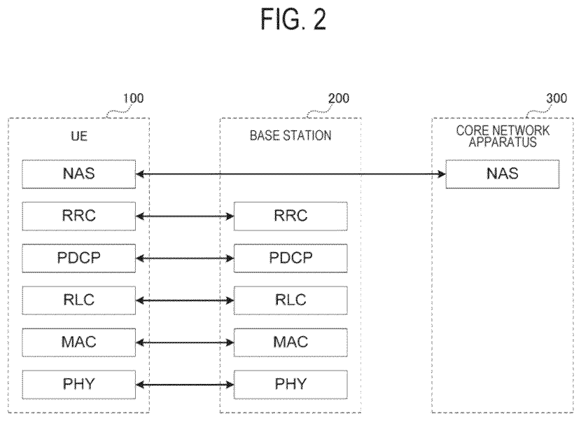

Next, a configuration example of the protocol stack according to the present embodiment will be described with reference to FIG. 2.

A protocol of a radio section between the UE 100 and the base station 200 includes a physical (PHY) layer, a medium access control (MAC) layer, a radio link control (RLC) layer, a packet data convergence protocol (PDCP) layer, and an RRC layer.

The PHY layer performs encoding and decoding, modulation and demodulation, antenna mapping and demapping, and resource mapping and demapping. Data and control information are transmitted between the PHY layer of the UE 100 and the PHY layer of the base station 200 via a physical channel.

The MAC layer performs priority control of data, retransmission processing by hybrid automatic repeat request (hybrid ARQ (HARQ)), a random access procedure, and the like. Data and control information are transmitted between the MAC layer of the UE 100 and the MAC layer of the base station 200 via a transport channel. The MAC layer of the base station 200 includes a scheduler. The scheduler determines uplink and downlink transport formats (transport block size and modulation and coding scheme (MCS)) and resources to be allocated to the UE 100.

The RLC layer transmits data to the RLC layer on the reception side using the functions of the MAC layer and the PHY layer. Data and control information are transmitted between the RLC layer of the UE 100 and the RLC layer of the base station 200 via a logical channel.

The PDCP layer performs header compression/decompression and encryption/decryption.

A service data adaptation protocol (SDAP) layer may be provided as an upper layer of the PDCP layer. The service data adaptation protocol (SDAP) layer performs mapping between an IP flow, which is a unit in which a core network performs QoS control, and a radio bearer, which is a unit in which an access stratum (AS) performs QoS control.

The RRC layer controls the logical channel, the transport channel, and the physical channel according to establishment, reestablishment, and release of the radio bearer. RRC signaling for various configurations is transmitted between the RRC layer of the UE 100 and the RRC layer of the base station 200. In a case where there is an RRC connection between the RRC of the UE 100 and the RRC of the base station 200, the UE 100 is in an RRC connected state. In a case where there is no RRC connection between the RRC of the UE 100 and the RRC of the base station 200, the UE 100 is in an RRC idle state. In a case where an RRC connection between the RRC of the UE 100 and the RRC of the base station 200 is suspended, the UE 100 is in an RRC inactive state.

An NAS layer located at a higher level than the RRC layer in the UE 100 performs session management and mobility management of the UE 100. NAS signaling is transmitted between the NAS layer of the UE 100 and the NAS layer of the core network apparatus 300.

Note that the UE 100 has an application layer and the like in addition to the protocol of the radio interface.

### (Radio Frame Configuration)

In the 5G system, downlink transmission and uplink transmission are configured in a radio frame of 10 ms duration. For example, the radio frame includes 10 subframes. For example, one subframe may be 1 ms. Furthermore, one subframe may include one or more slots. For example, the number of symbols forming one slot is 14 for a normal cyclic prefix (CP) and 12 for an extended CP. In addition, the number of slots forming one subframe changes depending on the configured subcarrier spacing. For example, for the normal CP, when 15 kHz is configured as the subcarrier spacing, the number of slots per subframe is 1 (that is, 14 symbols), when 30 kHz is configured as the subcarrier spacing, the number of slots per subframe is 2 (that is, 28 symbols), when 60 kHz is configured as the subcarrier spacing, the number of slots per subframe is 4 (that is, 56 symbols), and when 120 kHz is configured as the subcarrier spacing, the number of slots per subframe is 8 (that is, 128 symbols). In addition, for the extended CP, when 60 kHz is configured as the subcarrier spacing, the number of slots per subframe is 4 (that is, 48 symbols). That is, the number of slots forming one subframe is determined on the basis of the subcarrier spacing configured by the base station 200. In addition, the number of symbols forming one subframe is determined on the basis of the subcarrier spacing configured by the base station 200. That is, the number of symbols forming a subframe of 1 ms is determined on the basis of the subcarrier spacing configured by the base station 200, and the length (length in a time direction) of each symbol changes.

### (BWP)

A bandwidth part (hereinafter, BWP) is defined to reduce power consumption of the UE 100 and effectively utilize a broadband carrier. The BWP includes initial BWPs (an initial DL BWP and an initial UL BWP) and dedicated BWPs (a dedicated DL BWP and a dedicated UL BWP). Up to four DL BWPs and up to four UL BWPs are configured in one serving cell for the UE 100 according to the capability. In the following description, when the DL BWP and the UL BWP are not distinguished, they are simply referred to as the BWP.

The initial BWP is at least a BWP used for initial access, and is commonly used by a plurality of UEs 100. For each of the initial DL BWP and the initial UL BWP, a bwp-id, which is a BWP identifier, is defined as “0”. There are two types of initial BWPs: an initial BWP derived and configured by a master information block (MIB) transmitted on a PBCH; and an initial BWP configured by a system information block (SIB), specifically, a system information block type 1 (SIB1). The initial BWP configured by the MIB has a bandwidth corresponding to CORESET #0 configured using parameters included in the MIB. The initial BWP configured by the SIB1 is configured by various parameters (locationAndBandwidth, subcarrierSpacing, and cyclicPrefix) included in ServingCellConfigCommonSIB which is an information element in the SIB1.

Upon initial access to a cell, the UE 100 that has received a synchronization signal block (hereinafter, SSB) of the cell acquires a bandwidth (24, 48, or 96 RBs) of a Type-0 PDCCH CSS set from a setting value of controlResourceSetZero (an integer value from 0 to 15) in pdcch-ConfigSIB1 which is an information element included in the PBCH (MIB). Then, the UE 100 monitors the Type-0 PDCCH CSS set to acquire the SIB1, and acquires locationAndBandwidth, which is a parameter indicating a frequency location and/or bandwidth of the initial BWP, from the SIB1. The UE 100 uses the initial BWP configured by the MIB, that is, the bandwidth based on CORESET #0, as the initial BWP until a message 4 (Msg. 4) during a random access procedure in the initial access is received. On the other hand, after the Msg.4 is received, the UE 100 uses the bandwidth configured by locationAndBandwidth in the SIB1 as the initial BWP. Note that Msg.4 may be an RRCSetup message, an RRCResume message, or an RRCReestablishment message. The UE 100 transitions from, for example, an RRC idle state to an RRC connected state by such initial access (random access procedure).

The dedicated BWP is a BWP configured to be dedicated to a certain UE 100 (UE-specific BWP). For the dedicated BWP, a bwp-id other than “0” may be configured. For example, the dedicated DL BWP and the dedicated UL BWP are configured based on BWP-Downlink and BWP-Uplink, which are information elements included in SevingcellConfig in an RRC message that is dedicated signaling transmitted from the base station 200 to the UE 100. For example, each of BWP-Downlink and BWP-Uplink may include various parameters (locationAndBandwidth, subcarrierSpacing, and cyclicPrefix) for configuring the BWP.

The base station 200 can notify the UE 100 of a BWP (that is, an active BWP) used for communication with the base station 200 among one or more configured BWPs. Specifically, the base station 200 can transmit, to the UE 100, a BWP identifier indicating a BWP to be activated at the time of performing the configuration, that is, a BWP to be first used in communication with the base station 200. Furthermore, for example, switching by a PDCCH (DCI), RRC signaling, an MAC control element (MAC CE), or a timer is used for control of switching from an active BWP to a BWP that is not an active BWP (hereinafter, referred to as an inactive BWP) and switching from an inactive BWP to an active BWP.

Note that the communication in the active BWP may include at least one of transmission on an uplink-shared channel (UL-SCH) in the BWP, transmission on a random access channel (RACH) in the BWP (when a physical random access channel (physical RACH (PRACH)) occasion is configured), monitoring of a physical downlink control channel (PDCCH) in the BWP, transmission on a physical uplink control channel (PUCCH) in the BWP (when a PUCCH resource is configured), reporting of channel state information (CSI) for the BWP, and reception of a downlink-shared channel (DL-SCH) in the BWP.

Here, the UL-SCH is a transport channel and is mapped to a physical uplink shared channel (PUSCH), which is a physical channel. Data transmitted on the UL-SCH is also referred to as UL-SCH data. For example, the data may correspond to UL-SCH data and uplink user data. Further, the DL-SCH is a transport channel and is mapped to a physical downlink shared channel (PDSCH), which is a physical channel. Data transmitted on the DL-SCH is also referred to as DL-SCH data. For example, the data may correspond to DL-SCH data and downlink user data.

The PUCCH is used to transmit uplink control information (UCI). For example, the uplink control information includes a hybrid automatic repeat request (HARQ)-ACK, CSI, and/or a scheduling request (SR). The HARQ-ACK includes a positive acknowledgment or a negative acknowledgment. For example, the PUCCH is used to transmit HARQ-ACK for the PDSCH (that is, the DL-SCH (DL-SCH data and downlink user data)). Here, the DL-SCH data and/or the downlink user data are also referred to as a downlink transport block.

For example, the UE 100 monitors a set of PDCCH candidates in one or more control resource set(s) (CORESET(s)) on an active DL BWP. The monitoring of the PDCCH may include decoding each of the PDCCH candidates according to a monitored downlink control information (DCI) format. Here, the UE 100 may monitor a DCI format to which a cyclic redundancy check (CRC, which is also referred to as a CRC parity bit) scrambled by a radio network temporary identifier (RNTI) configured by the base station 200 is added. Here, the RNTI may include a system information-RNTI (SI-RNTI), a random access RNTI (RA-RNTI), a temporary C-RNTI (TC-RNTI), a paging RNTI (P-RNTI), and/or a cell-RNTI (C-RNTI). The set of PDCCH candidates monitored by the UE 100 may be defined as a search space set of PDCCHs. The search space set may include a common search space set(s) (CSS set(s)) and/or a UE specific search space set(s) (USS set(s)). Therefore, the base station 200 may configure the CORESET and/or the search space set in the UE 100, and the UE 100 may monitor the PDCCH in the configured CORESET and/or search space set.

### (SSB)

The base station 200 transmits a synchronization signal block (hereinafter, SSB) on the initial DL BWP. For example, the SSB includes four consecutive OFDM symbols, and a primary synchronization signal (PSS), a secondary synchronization signal (SSS), a PBCH (MIB), and a demodulation reference signal (DMRS) of the PBCH are arranged. A location of a resource element (time resource/frequency resource) to which the SSB is mapped is specified in the 3GPP technical specification, for example, “section 7.4.3.1” of “TS38.211 v16.2.0” and “section 4.1” of “TS38.213 v16.2.0”. Abandwidth of the SSB is, for example, a bandwidth of 240 consecutive subcarriers, that is, 20 RBs.

The SSB associated with the SIB1 is referred to as a cell defining-SSB (CD-SSB). From the viewpoint of one UE 100, one serving cell is associated with one CD-SSB. Note that the SIB1 is also referred to as remaining minimum system information (RMSI). One CD-SSB corresponds to one cell having a unique NR cell global identifier (NCGI). The SSB that is not associated with the SIB1 (RMSI) is referred to as a non-cell defining-SSB (Non-CD-SSB).

The base station 200 notifies the UE 100 of an SSB that is being transmitted, for example, by parameters (ssb-PositionsInBurst and ssb-periodicityServingCell) included in ServingCellConfigCommonSIB which is an information element in the SIB1. The ssb-PositionsInBurst indicates a time position of the SSB that is being transmitted in an SS burst of a half frame (5 ms). The ssb-periodicityServingCell indicates a transmission period of the SSB.

The UE 100 can grasp an SSB index of the SSB that is being transmitted based on the ssb-PositionsInBurst. Specifically, the maximum number (up to 64) of SSBs in the half frame is determined depending on the subcarrier spacing and the frequency band, and the UE 100 can specify a candidate location of the SSB in the time domain based on the SSB index. The UE 100 grasps whether or not the SSB is actually being transmitted at the candidate location based on the ssb-PositionsInBurst.

### (Specific Initial BWP)

In the 3GPP, assuming the specific UE 100B (RedCap UE), it is agreed to configure an initial BWP (second initial BWP) for the specific UE 100B (RedCap UE) independently of the conventional initial BWP. The newly introduced initial BWP is referred to as a specific initial BWP. The specific initial BWP may be referred to as a separate initial BWP or a RedCap-specific initial BWP. The specific initial BWP may be an initial BWP specific to the specific UE 100B.

The conventional initial BWP is a first initial BWP for the general UE 100 (non-RedCap UE). The first initial BWP may be used not only for the general UE 100A but also for the specific UE 100B. Therefore, the first initial BWP may be an initial BWP used for communication between the general UE 100A and the base station 200 and communication between the specific UE 100B and the base station 200.

On the other hand, the specific initial BWP is a second initial BWP different from the first initial BWP. The specific initial BWP may be exclusively used for the specific UE 100B. The specific initial BWP may be an initial BWP that is not used for communication between the general UE 100A and the base station 200, but is used for communication between the specific UE 100B and the base station 200. When the specific initial BWP is configured for the specific UE 100B (for example, when the specific UE 100 receives configuration information for specifying the specific initial BWP from the base station 200), the specific UE 100B may perform a random access procedure on the specific initial BWP that is the second initial BWP rather than the first initial BWP. (Only) when the specific initial BWP is not configured for the specific UE 100B, the specific UE 100B may perform the random access procedure on the first initial BWP.

A bandwidth of the specific initial BWP may be equal to or less than the maximum bandwidth of the specific UE 100B (RedCap UE). A frequency band of the specific initial BWP may be configured in such a way as not to overlap a frequency band of the conventional initial BWP to prevent UL transmission of the general UE 100 (non-RedCap UE) from being adversely affected.

For example, the base station 200 transmits a parameter (for example, locationAndBandwidth) indicating the frequency location and/or bandwidth for each of the specific initial DL BWP and/or the specific initial UL BWP by the SIB1. Note that the parameters such as the subcarrier spacing and the cyclic prefix (for example, subcarrierSpacing and cyclicPrefix) for each of the specific initial DL BWP and/or the specific initial UL BWP may or may not be configured. The CORESET #0 may not be configured for the specific initial DL BWP. In addition, the SIB1 may not be transmitted on the specific initial DL BWP.

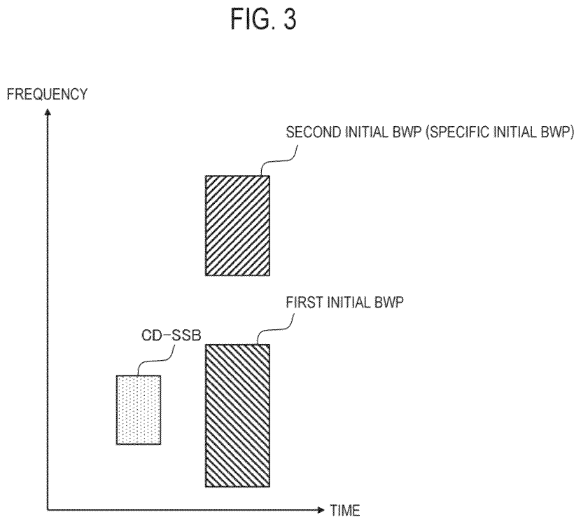

In the embodiment, it is assumed that no CD-SSB is present (that is, no CD-SSB is transmitted) in the specific initial DL BWP. FIG. 3 illustrates an example of a relationship between the SSB and the initial BWP. In the example illustrated in FIG. 3, the base station 200 (cell) transmits the CD-SSB in the frequency band of the first initial BWP, and does not transmit the CD-SSB in the frequency band of the second initial BWP. Note that the Non-CD-SSB may be transmitted within the frequency band of the second initial BWP.

### (Assumed Scenario)

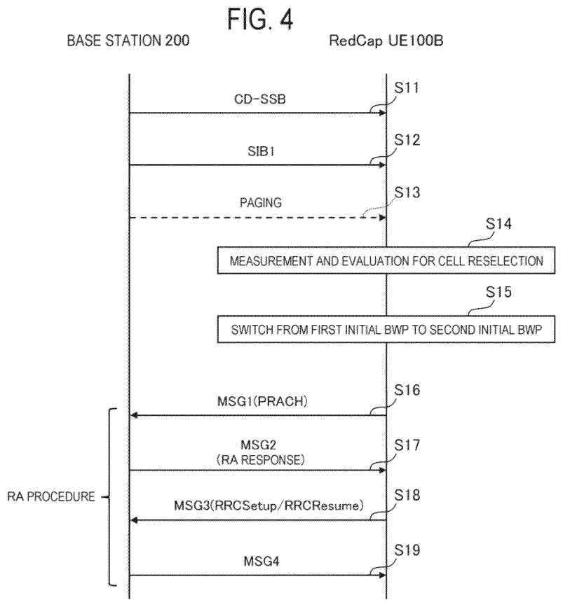

A scenario assumed in the mobile communication system 1 according to the embodiment will be described with reference to FIGS. 3 and 4. FIG. 4 illustrates an operation example of the UE in an RRC idle state or an RRC inactive state. The description will proceed assuming that the UE is the specific UE 100B. As illustrated in FIG. 3, a CD-SSB is present on the first initial BWP, and no CD-SSB is present on the second initial BWP.

### Step S11:

The base station 200 transmits a CD-SSB on the first initial BWP. The specific UE 100B receives the CD-SSB from the base station 200 on the first initial BWP. The specific UE 100B can synchronize the time and/or the frequency by receiving (that is, detecting) the CD-SSB transmitted from the base station 200.

In addition, the specific UE 100B acquires an MIB by receiving the CD-SSB. The specific UE 100B configures the initial BWP on the basis of CORESET #0 configured on the basis of the MIB. The initial BWP (initial downlink BWP) configured on the basis of the CORESET #0 may be referred to as an “MIB Configured Initial DL BWP” or an “Initial DL BWP derived by MIB”. Hereinafter, the initial BWP (initial downlink BWP) configured on the basis of the CORESET #0 may be referred to as an MIB initial BWP. The specific UE 100B specifies a type 0-PDCCH CSS set (for example, a bandwidth (24, 48, or 96 RB)) on the basis of, for example, a configuration value indicated by controlResourceSetZero in the MIB. Accordingly, the type 0-PDCCH CSS set is configured in the specific UE 100B. The specific UE 100B monitors a system information block (specifically, the SIB1) in the type 0-PDCCH CSS set by using the MIB initial BWP.

### Step S12:

The base station 200 transmits the SIB1. The specific UE 100B receives the SIB1 from the base station 200. The SIB1 includes first configuration information for configuring the first initial BWP and second configuration information for configuring the second initial BWP.

As will be described below, the specific UE 100B communicates with the base station 200 on the first initial BWP based on the first configuration information, and communicates with the base station 200 on the second initial BWP based on the second configuration information.

### Step S13:

The base station 200 and the specific UE 100B may execute paging. The base station 200 transmits a PDCCH (a DCI format (a paging DCI) to which a CRC scrambled by P-RNTI is added) in a corresponding CORESET and/or search space set (type 2-PDCCH CSS set).

The specific UE 100B may monitor the PDCCH (paging DCI) on the first initial BWP. The specific UE 100B may receive a paging message on the basis of scheduling information included in the paging DCI. The specific UE 100B determines whether or not its own unique identifier is included in the paging message. When the identifier of the specific UE 100B is included in the paging message, the specific UE 100B may perform, for example, an operation of transitioning to the RRC connected state, assuming that there is a call.

### Step S14:

The specific UE 100B executes cell reselection and measurement in the CD-SSB. Specifically, the specific UE 100B executes processing of detecting a CD-SSB, processing of measuring a radio quality with respect to the detected CD-SSB, and processing of evaluating a measurement result as the execution of the measurement. The specific UE 100B executes cell reselection when the condition for cell reselection is fulfilled by the evaluation processing.

### Step S15:

When performing a random access (RA) procedure, the specific UE 100B switches the first initial BWP to the second initial BWP since the specific initial BWP is configured.

Thereafter, the random access (RA) procedure is executed between the specific UE 100B and the base station 200.

### Step S16:

The specific UE 100B transmits a message 1 (hereinafter, MSG1) to the base station 200 using the specific initial BWP. The specific UE 100B transmits the MSG 1 including a random access (RA) preamble via the physical random access channel (PRACH) on the specific initial BWP. The base station 200 (the receiver 221) receives the MSG1 from the specific UE 100B.

### Step S17:

The base station 200 transmits a message 2 (hereinafter, MSG2) to the specific UE 100B. The MSG2 is a random access (RA) response. The specific UE 100B (the receiver 121) receives the MSG2 from the base station 200.

The MSG2 includes, for example, preamble information indicating the RA preamble received from the specific UE 100B, an uplink grant (UL grant) indicating time-frequency resources used for the UE 100 to transmit a message 3, and the like. The time-frequency resources may be located at a frequency on the specific initial BWP.

The specific UE 100B that has received the RA response performs processing in step S18 when the RA preamble transmitted by itself coincides with the RA preamble indicated by the preamble information received from the base station 200 in step S17.

### Step S18:

The specific UE 100B (the transmitter 122) transmits a message 3 (hereinafter, MSG3) to the base station 200. The specific UE 100B (the transmitter 122) transmits the MSG3 to the base station 200 in the time-frequency resources allocated by the uplink grant. The base station 200 (the receiver 221) receives the MSG3 from the specific UE 100B.

The MSG3 may include a request message for establishing an RRC connection or resuming the RRC connection. The request message for establishing an RRC connection may be an RRC setup request (RRCSetupRequest) message transmitted by the UE in the RRC idle state. The request message for resuming the RRC connection may be an RRC resume request (RRCResumeRequest or RRCResumeRequest1) message transmitted by the UE in the RRC inactive state.

### Step S19:

The base station 200 transmits a message 4 (hereinafter, MSG4) to the specific UE 100B. The base station 200 (the transmitter 222) transmits the MSG4 by using the specific initial BWP. The specific UE 100B receives the MSG4 from the base station 200 using the specific initial BWP.

The MSG4 is a response to the request message. The MSG4 may be an RRC setup message for the RRC setup request or an RRC resume message for the RRC resume request message. Furthermore, the MSG4 may be an RRC rejection message for rejecting the establishment of the RRC connection or the resumption of the RRC connection.

The specific UE 100B transitions from the RRC idle state or the RRC inactive state to the RRC connected state when the random access procedure succeeds. Thereafter, the specific UE 100B in the RRC connected state can communicate with the base station 200 using the dedicated BWP.

Here, it is assumed that the specific UE 100B in the RRC idle state or the RRC inactive state attempts to establish or resume an RRC connection according to, for example, a random access procedure on the specific initial BWP in which a CD-SSB is not present, and the establishment or resumption of the RRC connection fails. In this case, since the CD-SSB is not present on the specific initial BWP, the specific UE 100B may not be able to execute paging monitoring, cell (re)selection, and measurement, and may not be able to execute an appropriate operation. In an embodiment to be described below, an operation for executing an appropriate operation even when no CD-SSB is present on the specific initial BWP will be described.

In addition, the specific UE 100B in the RRC idle state or the RRC inactive state continues the measurement processing and the evaluation processing for cell reselection even after transmitting the request message for establishing an RRC connection or resuming the RRC connection. Therefore, on the specific initial BWP in which no CD-SSB is present, the specific UE 100B may perform a useless operation of attempting measurement and evaluation for cell reselection even though no CD-SSB is present on the specific initial BWP after transmitting the request message for establishing an RRC connection or resuming the RRC connection. In an embodiment to be described below, an operation for suppressing a useless operation to be suppressed even when no CD-SSB is present on the specific initial BWP will be described.

### (Configuration of User Equipment)

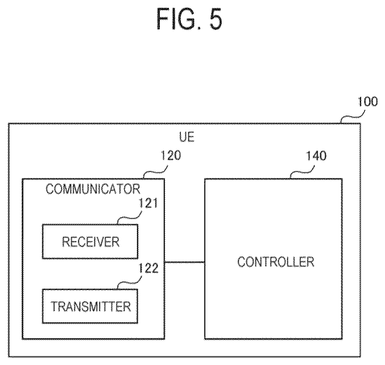

Next, a configuration of the UE 100 according to the present embodiment will be described with reference to FIG. 5. The UE 100 includes a communicator 120 and a controller 140.

The communicator 120 performs radio communication with the base station 200 by transmitting and receiving radio signals to and from the base station 200. The communicator 120 includes at least one receiver 121 and at least one transmitter 122. Each of the receiver 121 and the transmitter 122 may include an antenna and an RF circuit. The antenna converts a signal into a radio wave and emits the radio wave into a space. Further, the antenna receives a radio wave in a space and converts the radio wave into a signal. The RF circuit performs analog processing on the signals transmitted and received via the antenna. The RF circuit may include a high frequency filter, an amplifier, a modulator, a low pass filter, and the like.

The receiver 121 may be referred to as a receiver (RX). The transmitter 122 may be referred to as a transmitter (TX). In a case where the UE 100 is the general UE 100A, the number of receivers included in the communicator 120 may be two to four. In a case where the UE 100 is the specific UE 100B, the number of receivers included in the communicator 120 may be one or two.

The controller 140 performs various types of control in the UE 100. The controller 140 controls communication with the base station 200 via the communicator 120. An operation of the UE 100 to be described below may be an operation performed under the control of the controller 140. The controller 140 may include at least one processor capable of executing a program and a memory that stores the program. The processor may execute the program to perform the operation of the controller 140. The controller 140 may include a digital signal processor that performs digital processing on the signals transmitted and received via the antenna and the RF circuit. The digital processing includes processing of the protocol stack of the RAN. Further, the memory stores a program to be executed by the processor, parameters related to the program, and data related to the program. The memory may include at least one of a read only memory (ROM), an erasable programmable read only memory (EPROM), an electrically erasable programmable read only memory (EEPROM), a random access memory (RAM), and a flash memory. All or a part of the memory may be included in the processor.

The UE 100 configured in this manner is the specific UE 100B having a communication capability reduced as compared with the general UE 100A. In a radio resource control (RRC) idle state or an RRC inactive state, the controller 140 performs a random access procedure using a specific initial BWP for the specific UE 100B, which is a bandwidth part (BWP) that is a part of the bandwidth of the cell of the base station 200. When the random access procedure fails with no CD-SSB being present on the specific initial BWP, the controller 140 switches the specific initial BWP to an initial BWP in which a CD-SSB is present. As a result, the specific UE 100B executes paging monitoring, cell (re)selection, and measurement on the initial BWP in which the CD-SSB is present, rather than the specific initial BWP in which the CD-SSB is not present, so that the specific UE 100B can execute appropriate communication.

Furthermore, the random access procedure may include processing of transmitting a random access preamble to the base station 200 and processing of receiving a response to the random access preamble from the base station. When the number of times no response can be received from the base station 200 as a failure of the random access procedure reaches a designated number of times, the controller 140 may switch the specific initial BWP to the initial BWP.

In addition, the random access procedure may include processing of transmitting a request message for establishing an RRC connection or resuming the RRC connection to the base station 200 and processing of receiving a response to the request message from the base station. When an RRC rejection message is received from the base station 200 as a response to the request message, the controller 140 may switch the specific initial BWP to the initial BWP.

Further, the transmitter 122 may transmit a request message for establishing an RRC connection to the base station 200. When a response to the request message is not received from the base station within a designated time after the request message is transmitted, the controller 140 may switch the specific initial BWP to the initial BWP.

Further, the transmitter 122 may transmit a request message for resuming the RRC connection to the base station 200. When a response to the request message is not received from the base station 200 within a designated time after the request message is transmitted, the controller 140 may switch the specific initial BWP to the initial BWP.

Further, the transmitter 122 may transmit a request message for resuming the RRC connection to the base station 200. When an integrity check failure indication indicating a failure of an integrity check is sent to the RRC layer from a lower layer within a designated time after the request message is received, the controller 140 may switch the specific initial BWP to the initial BWP.

Furthermore, when a CD-SSB is present on the specific initial BWP, the controller 140 may perform control to execute at least one of paging monitoring, cell selection, cell reselection, and measurement on the specific initial BWP after the failure of the random access procedure.

The specific initial BWP may be an initial BWP that is not used for communication between the general UE 100A and the base station 200, but is used for communication between the specific UE 100B and the base station 200.

The specific initial BWP may be an initial BWP used for communication between the general UE 100A and the base station 200 and communication between the specific UE 100B and the base station 200.

In addition, in an RRC idle state or an RRC inactive state, the controller 140 performs a random access procedure using a specific initial BWP for the specific UE 100B, which is a bandwidth part (BWP) that is a part of the bandwidth of the cell of the base station 200. In the random access procedure, the transmitter 122 transmits a request message for establishing an RRC connection or resuming the RRC connection to the base station 200. In a case where no CD-SSB is present on the specific initial BWP, when an RRC rejection message is received from the base station 200 as a response to the request message, the controller 140 switches the specific initial BWP to the initial BWP. As a result, when the RRC rejection message is received, the specific UE 100B executes paging monitoring, cell (re)selection, and measurement on the initial BWP in which the CD-SSB is present, rather than the specific initial BWP in which the CD-SSB is not present, so that the specific UE 100B can execute appropriate communication.

In addition, in an RRC idle state or an RRC inactive state, the controller 140 performs a random access procedure using a specific initial BWP for the second communication apparatus, which is a BWP that is a part of the bandwidth of the cell of the base station 200. In the random access procedure, the transmitter 122 transmits a request message for establishing an RRC connection or resuming the RRC connection to the base station (200). In a case where no CD-SSB is present on the specific initial BWP, when a response to the request message is not received from the base station 200 within a designated time after the request message is transmitted, the controller 140 switches the specific initial BWP to the initial BWP. As a result, when no response to the request message is received from the base station 200 within the designated time, the specific UE 100B executes paging monitoring, cell (re)selection, and measurement on the initial BWP in which the CD-SSB is present, rather than the specific initial BWP in which the CD-SSB is not present, so that the specific UE 100B can execute appropriate communication.

In addition, in an RRC idle state or an RRC inactive state, the controller 140 performs a random access procedure using a specific initial BWP for the second communication apparatus, which is a bandwidth part (BWP) that is a part of the bandwidth of the cell of the base station 200. In the random access procedure, the transmitter 122 transmits a request message for resuming the RRC connection to the base station (200). In a case where no CD-SSB is present on the specific initial BWP, when an integrity check failure indication indicating a failure of an integrity check is sent to the RRC layer from a lower layer within a designated time after the request message is received, the controller 140 may switch the specific initial BWP to the initial BWP. As a result, when the integrity check failure indication is sent to the RRC layer from the lower layer, the specific UE 100B executes paging monitoring, cell (re)selection, and measurement on the initial BWP in which the CD-SSB is present, rather than the specific initial BWP in which the CD-SSB is not present, so that the specific UE 100B can execute appropriate communication.

In addition, the designated communication capability may be a capability based on at least one of a maximum bandwidth used for radio communication and the number of receivers. The second communication apparatus may be at least one of an apparatus having a narrower maximum bandwidth than the first communication apparatus and an apparatus having a smaller number of receivers than the first communication apparatus.

In addition, the second communication apparatus may be a reduced capability new radio device (reduced capability NR device) in a 5th generation system of the 3rd generation partnership project standard.

In addition, the transmitter 122 transmits a request message for establishing an RRC connection or resuming the RRC connection to the base station 200 on the specific initial BWP. After the request message is transmitted, the controller 140 executes measurement processing and evaluation processing for cell reselection. When no CD-SSB is present on the specific initial BWP, the controller performs control to interrupt at least one of the measurement processing and the evaluation processing after the request message is transmitted. As a result, the specific UE 100B can suppress a useless operation of attempting measurement and evaluation for cell reselection even though no CD-SSB is present on the specific initial BWP. In addition, even though it is attempted to establish or resume the RRC connection on the specific initial BWP, the specific UE 100B can suppress a useless operation of attempting measurement and evaluation for cell reselection by switching the BWP to the initial BWP.

Furthermore, the controller 140 may perform control to interrupt at least one of the measurement processing and the evaluation processing until the transition to the RRC connected state after the request message is transmitted.

Further, the receiver 121 may receive a response to the request message from the base station 200. When an RRC rejection message is received as a response from the base station 200, the controller 140 may perform control to switch the specific initial BWP to the initial BWP and execute the measurement processing and the evaluation processing on the initial BWP.

Further, the transmitter 122 may transmit a request message for establishing an RRC connection to the base station 200. When no response to the request message is received from the base station 200 within a designated time after the request message is transmitted, the controller 140 may perform control to switch the specific initial BWP to the initial BWP and execute the measurement processing and the evaluation processing on the initial BWP.

Further, the transmitter 122 may transmit a request message for resuming the RRC connection to the base station 200. When no response to the request message is received from the base station 200 within a designated time after the request message is transmitted, the controller 140 may perform control to switch the specific initial BWP to the initial BWP and execute the measurement processing and the evaluation processing on the initial BWP.

Further, the transmitter 122 may transmit a request message for resuming the RRC connection to the base station 200. When an integrity check failure indication indicating a failure of an integrity check is sent to the RRC layer from a lower layer within a designated time after the request message is transmitted, the controller 140 may perform control to switch the specific initial BWP to the initial BWP and execute measurement processing and evaluation processing on the initial BWP.

Note that the operation of the functional unit (specifically, at least one of the communicator 120 and the controller 140) included in the UE 100 may be described as an operation of the UE 100.

### (Configuration of Base Station)

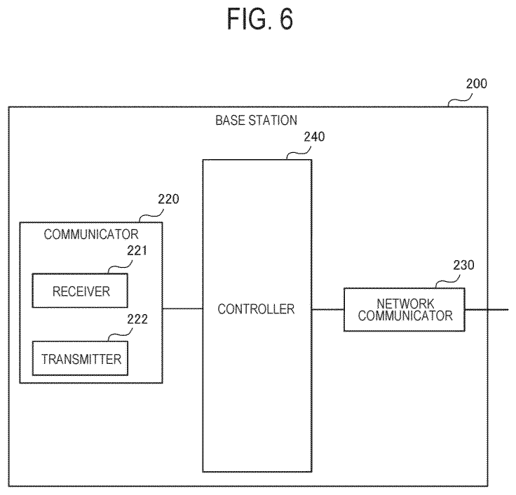

Next, a configuration of the base station 200 according to the present embodiment will be described with reference to FIG. 6. The base station 200 includes a radio communicator 220, a network communicator 230, and a controller 240.

The radio communicator 220 performs communication with the ULE 100 via the antenna under the control of the controller 240. The radio communicator 220 includes a receiver 221 and a transmitter 222. The receiver 221 converts a radio signal received by the antenna into a received signal that is a baseband signal, performs signal processing on the received signal, and outputs the processed signal to the controller 240. The transmitter 222 performs signal processing on a transmitted signal that is a baseband signal output from the controller 240, converts the processed transmitted signal into a radio signal, and transmits the radio signal from the antenna.

The network communicator 230 transmits and receives signals to and from the network. The network communicator 230 receives a signal from a neighboring base station connected via, for example, an Xn interface, which is an interface between base stations, and transmits a signal to the neighboring base station. Further, the network communicator 230 receives a signal from the core network apparatus 300 connected via, for example, an NG interface, and transmits a signal to the core network apparatus 300.

The controller 240 performs various types of control in the base station 200. The controller 240 controls, for example, communication with the UE 100 via the radio communicator 220. Further, the controller 240 controls, for example, communication with a node (for example, the neighboring base station or the core network apparatus 300) via the network communicator 230. An operation of the base station 200 to be described below may be an operation performed under the control of the controller 240.

The controller 240 may include at least one processor capable of executing a program and a memory that stores the program. The processor may execute the program to perform the operation of the controller 240. The controller 240 may include a digital signal processor that performs digital processing on the signals transmitted and received via the antenna and the RF circuit. The digital processing includes processing of the protocol stack of the RAN. Further, the memory stores a program to be executed by the processor, parameters related to the program, and data related to the program. All or a part of the memory may be included in the processor.

Note that the operation of the functional unit (specifically, at least one of the radio communicator 220 (the receiver 221 and/or the transmitter 222), the network communicator 230, and the controller 240) included in the base station 200 may be described as an operation of the base station 200.

### Operation Example

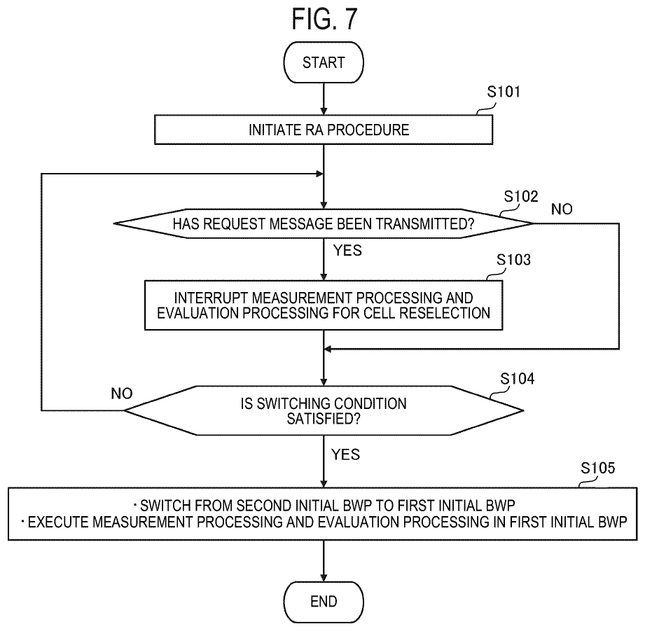

An operation example of the UE 100 (specifically, the specific UE 100B) will be described with reference to FIGS. 7 to 14. This operation example is based on the above-described configuration and operation. Therefore, the previous explanations may be omitted.

The specific UE 100B is in an RRC idle state or an RRC inactive state. In a case where a BWP used for communication with the base station 200 switches from a first initial BWP to a second initial BWP (that is, a specific initial BWP), when no CD-SSB is present on the second initial BWP, the specific UE 100B can execute the following processing. In addition, when a specific initial BWP in which no CD-SSB is present is configured in the specific UE 100B and a current BWP (specifically, a downlink BWP) is a specific initial BWP (specifically, a specific initial downlink BWP), the following processing may be executed.

Note that the specific UE 100B (the controller 140) can specify the center frequency at which a CD-SSB is present by cell search. When the frequency of the second initial BWP, which is a switching destination, includes the center frequency where the CD-SSB is present, the specific UE 100B (the controller 140) determines that the CD-SSB is present on the second initial BWP. On the other hand, the frequency of the second initial BWP, which is a switching destination, does not include the center frequency where the CD-SSB is present, the specific UE 100B (the controller 140) determines that the CD-SSB is not present on the second initial BWP.

### Step S101:

The controller 140 initiates a random access (RA) procedure. Specifically, in FIG. 7, the controller 140 performs control to execute processing of step S101

### Step S102:

The controller 140 determines whether or not a request message for establishing an RRC connection or resuming the RRC connection has been transmitted. When the request message has been transmitted, the controller 140 executes processing of step S103. When the request message has not been transmitted, the controller 140 executes processing of step S104.

### Step S103:

The controller 140 performs control to interrupt at least one of measurement processing and evaluation processing for cell reselection. The controller 140 performs control to interrupt both the measurement processing and the evaluation processing.

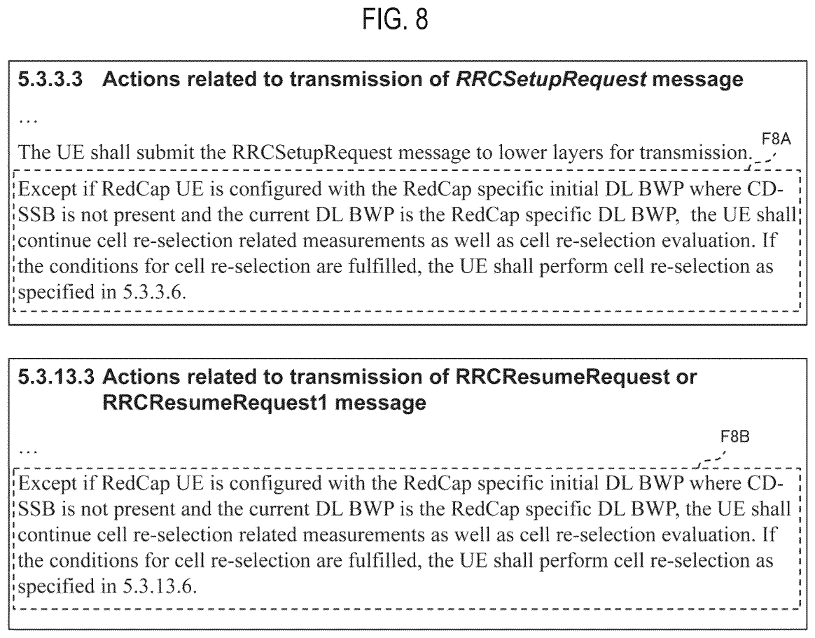

After transmitting an RRC setup request message, the controller 140 may perform control to interrupt both the measurement processing and the evaluation processing (see F8A of FIG. 8). In addition, after transmitting an RRC resume request message or an RRC resume request message 1, the controller 140 may perform control to interrupt both the measurement processing and the evaluation processing (see F8B of FIG. 8).

The controller 140 may perform control to interrupt at least one of the measurement processing and the evaluation processing until the transition to the RRC connected state after the request message is transmitted.

When a CD-SSB transmitted from a neighboring cell can be received on the second initial BWP, the controller 140 may execute measurement processing and evaluation processing on the CD-SSB transmitted from the neighboring cell.

In this manner, the controller 140 continues to use the second initial BWP as an active BWP, rather than executing processing of switching the BWP from the second initial BWP. The controller 140 performs control to interrupt at least one of the measurement processing and the evaluation processing while using the second initial BWP.

### Step S104:

The controller 140 determines whether or not a switching condition is fulfilled. When the condition is fulfilled, the controller 140 executes processing of step S105. When the condition is not fulfilled, the controller 140 executes the processing of step S102. Note that, when the RA procedure has succeeded, the controller 140 may end the processing in this operation example.

For example, the controller 140 determines that the switching condition is fulfilled in at least one of the following cases.

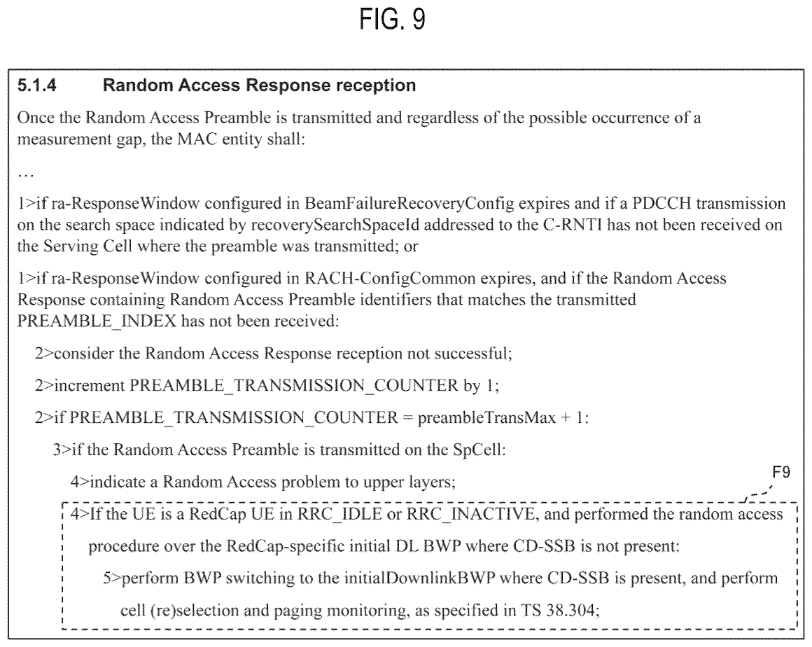

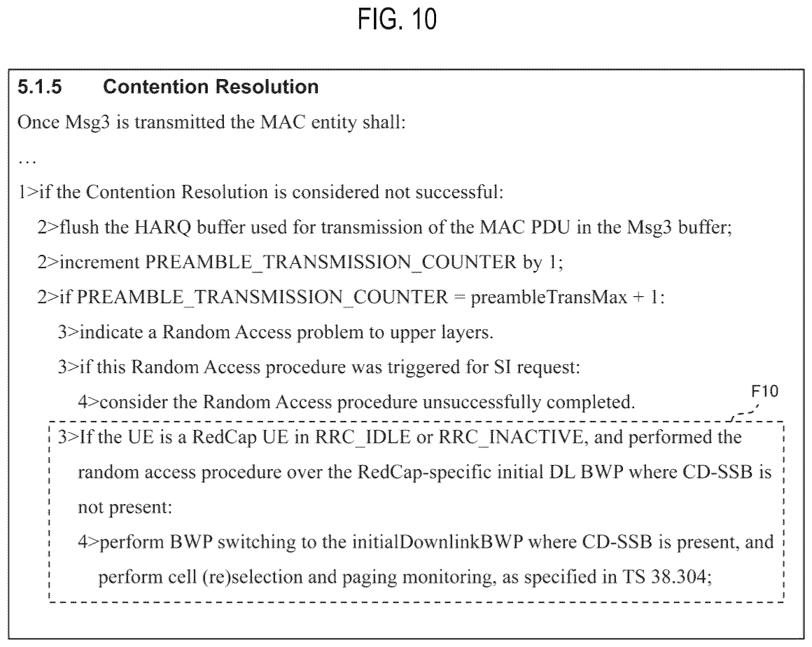

Firstly, the controller 140 may determine that the RA procedure has failed when the number of times no response can be received from the base station 200 has reached a designated number. When it is determined that the RA procedure has failed, the controller 140 may determine that the switching condition is fulfilled. As illustrated in FIG. 9, for example, in a case where it is determined that the reception of the random access response has failed, the controller 140 increments the preamble transmission counter by 1. In addition, as illustrated in FIG. 10, for example, in a case where it is determined that contention resolution has not succeeded, the controller 140 increments the preamble transmission counter by 1. When the preamble transmission counter exceeds an upper limit value (that is, preambleTransMax), the controller 140 may determine that the RA procedure has failed.

Secondly, the controller 140 may determine that the switching condition is fulfilled when a random access problem is indicated to upper layers in the MAC layer. As illustrated in FIGS. 9 and 10, for example, the controller 140 performs control to transmit a random access preamble on the Sp cell. The controller 140 may determine that the switching condition is fulfilled when a random access problem is indicated to upper layers in the MAC layer based on the transmission of the random access preamble.

Thirdly, the controller 140 may determine that the switching condition is fulfilled when no response to a request message for establishing an RRC connection is received from the base station 200 within a designated time after the request message is transmitted. Specifically, the controller 140 may start a first timer (specifically, a timer T300) that clocks a designated time after an RRC setup request (RRCSetupRequest) message is transmitted. Before the first timer expires, when an RRC setup message or an RRC rejection message is received, the controller 140 performs cell reselection, and when the establishment of the connection is aborted in a layer higher than the MAC layer, the controller 140 stops the first timer. The controller 140 may determine that the switching condition is fulfilled when the first timer has expired.

Fourthly, the controller 140 may determine that the switching condition is fulfilled when no response to a request message for resuming the RRC connection is received from the base station 200 within a designated time after the request message is transmitted. Specifically, the controller 140 may start a second timer (specifically, a timer T319) that clocks a designated time after an RRC resume request (RRCResumeRequest or RRCResumeRequest1) message is transmitted. Before the second timer expires, when an RRC resume message, an RRC setup message, an RRC release message, an RRC release message with suspend configuration (suspendConfig), or an RRC rejection message is received, the controller 140 performs cell reselection, and when the establishment of the connection is aborted in a layer higher than the MAC layer, the controller 140 stops the second timer. The controller 140 may determine that the switching condition is fulfilled when the second timer has expired.

Fifthly, the controller 140 may determine that the switching condition is fulfilled when an integrity check failure indication indicating a failure of an integrity check is sent to the RRC layer from a lower layer within a designated time after a request message for resuming the RRC connection is transmitted. Specifically, the controller 140 may determine that the switching condition is fulfilled when the integrity check failure indication is sent to the RRC layer from the lower layer while the second timer is running. Note that on a signaling radio bearer (SRB), which is a bearer that transmits an RRC message and an NAS message, the integrity check failure indication is sent to the RRC layer from the lower layer when an integrity check fails in a security and decoding process.

Sixthly, the controller 140 may determine that the switching condition is fulfilled when an RRC rejection message is received from the base station 200 as a response to a request message for establishing an RRC connection or resuming the RRC connection.

### Step S105:

The controller 140 performs control to switch the specific initial BWP (that is, the second initial BWP) to the initial BWP (that is, the first initial BWP). Specifically, the controller 140 performs control to switch the specific initial BWP to the initial BWP when the switching condition is fulfilled, for example, when the RA procedure has failed. For example, the controller 140 may switch the specific initial BWP to the initial BWP in at least one of the following cases.

Firstly, the controller 140 may switch the specific initial BWP to the initial BWP when the number of times no response can be received from the base station 200 reaches a designated number of times (see F9 of FIG. 9 and F10 of FIG. 10).

Secondly, the controller 140 may switch the specific initial BWP to the initial BWP when a random access problem is indicated to upper layers in the MAC layer (see F9 of FIG. 9 and F10 of FIG. 10.).

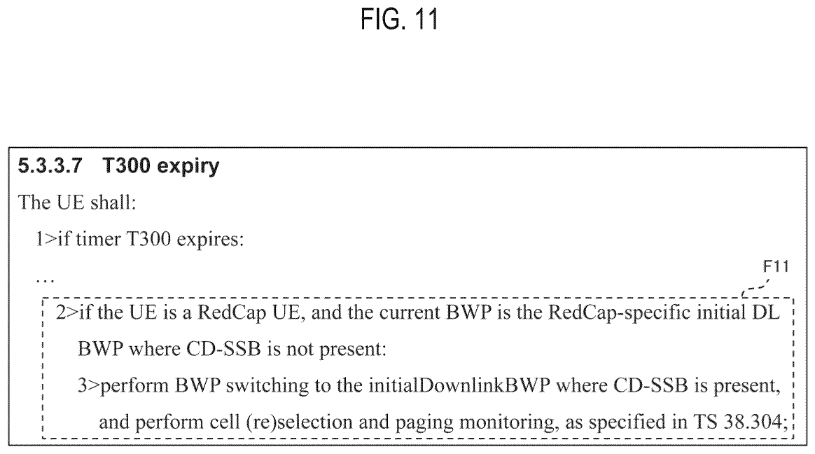

Thirdly, the controller 140 may switch the specific initial BWP to the initial BWP when no response to a request message for establishing an RRC connection is received from the base station 200 within a designated time after the request message is transmitted (see F11 of FIG. 11).

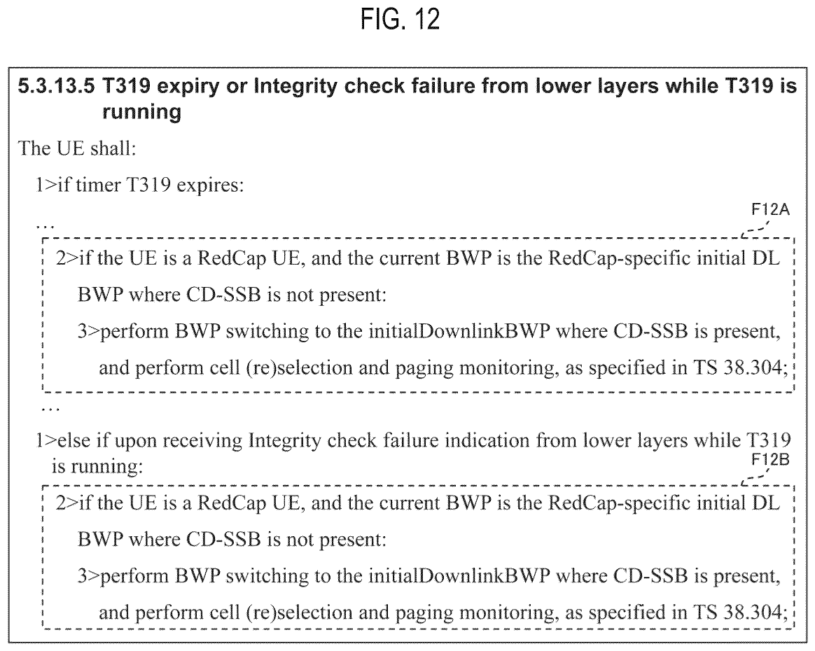

Fourthly, the controller 140 may switch the specific initial BWP to the initial BWP when no response to a request message for resuming the RRC connection is received from the base station 200 within a designated time after the request message is transmitted (see F12A of FIG. 12).

Fifthly, the controller 140 may switch the specific initial BWP to the initial BWP when an integrity check failure indication indicating a failure of an integrity check is sent to the RRC layer from a lower layer within a designated time after a request message for resuming the RRC connection is transmitted (see F12B of FIG. 12).

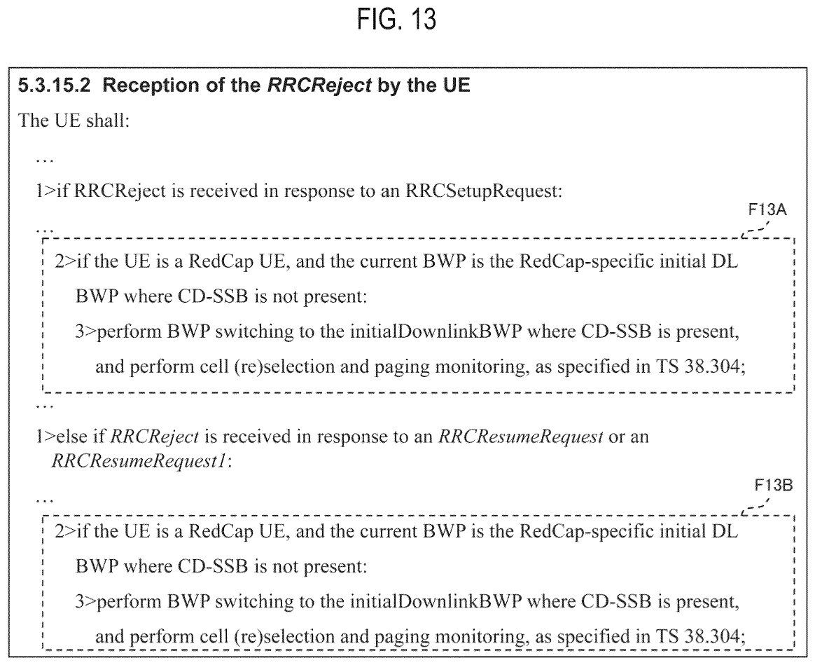

Sixthly, the controller 140 may switch the specific initial BWP to the initial BWP when an RRC rejection message is received from the base station 200 as a response to a request message for establishing an RRC connection or resuming the RRC connection (see F13A and F13B of FIG. 13).

Note that the controller 140 may switch the specific initial BWP to the initial BWP assuming that the switching condition is fulfilled based on a trigger different from the above-described trigger.

After switching to the initial BWP, the controller 140 performs control to execute measurement processing and evaluation processing on the first initial BWP. Therefore, the controller 140 may perform control to resume the measurement processing and the evaluation processing after switching to the initial BWP. In addition, the controller 140 may execute cell (re)selection and paging monitoring after switching to the initial BWP (see FIGS. 9 to 12).

As described above, the controller 140 performs a random access procedure using a specific initial BWP in an RRC idle state or an RRC inactive state. When the random access procedure fails with no CD-SSB being present on the specific initial BWP, the controller 140 switches the specific initial BWP to an initial BWP in which a CD-SSB is present. In addition, the controller 140 switches the specific initial BWP to the initial BWP when an RRC rejection message is received from the base station 200.

In addition, in a case where no CD-SSB is present on the specific initial BWP, when a response to the request message is not received from the base station 200 within a designated time after the request message is transmitted, the controller 140 switches the specific initial BWP to the initial BWP. In addition, in a case where no CD-SSB is present on the specific initial BWP, when an integrity check failure indication is sent to the RRC layer from a lower layer within a designated time after the request message is received, the controller 140 switches the specific initial BWP to the initial BWP. As a result, the specific UE 100B executes paging monitoring, cell (re)selection, and measurement on the initial BWP in which the CD-SSB is present, rather than the specific initial BWP in which the CD-SSB is not present, so that the specific UE 100B can execute appropriate communication.

In addition, the transmitter 122 transmits a request message for establishing an RRC connection or resuming the RRC connection to the base station 200 on the specific initial BWP. After the request message is transmitted, the controller 140 executes measurement processing and evaluation processing for cell reselection. When no CD-SSB is present on the specific initial BWP, the controller 140 performs control to interrupt at least one of the measurement processing and the evaluation processing after the request message is transmitted. As a result, the specific UE 100B can suppress a useless operation of attempting measurement and evaluation for cell reselection even though no CD-SSB is present on the specific initial BWP. In addition, even though it is attempted to establish or resume the RRC connection in the specific initial BWP, the specific UE 100B can suppress a useless operation of attempting measurement and evaluation for cell reselection by switching the BWP to the initial BWP.

### OTHER EMBODIMENTS

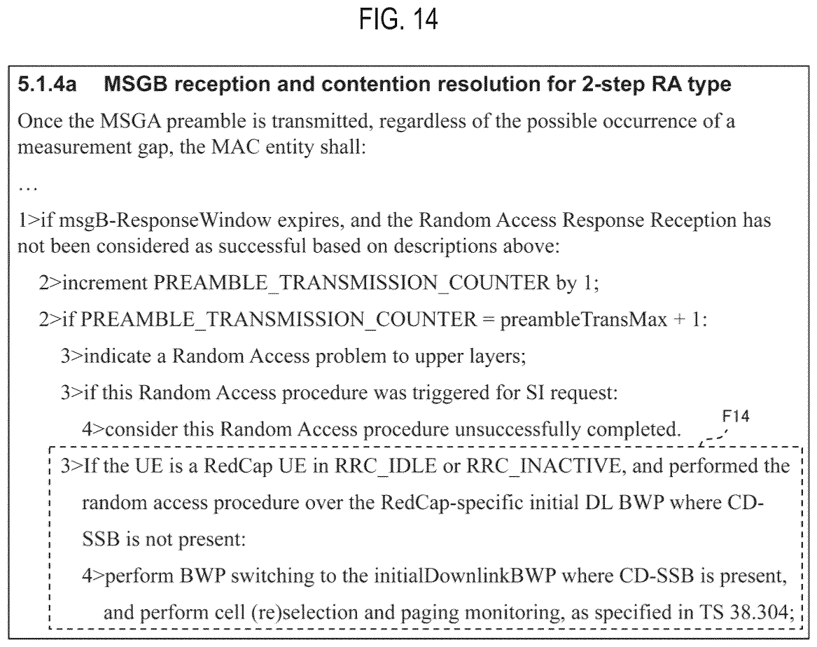

In the above-described embodiment, it has been described that the RA procedure is in a four-step random access (RA) type, but is not limited thereto. For example, the above-described operation may be performed in a case where the RA procedure is in a two-step RA type. For example, after a preamble and a payload is transmitted (that is, after MSGA is transmitted) in the RA procedure in the two-step RA type, when the switching condition is fulfilled, for example, when the RA procedure has failed, the controller 140 may switch the specific initial BWP to the initial BWP (see F14 of FIG. 14). After switching the specific initial BWP to the initial BWP, the controller 140 may execute cell (re)selection and paging monitoring.

In the above-described embodiment, it has been described that no CD-SSB is present on the specific initial BWP. In a case where a CD-SSB is present on the specific initial BWP, after the RA procedure fails, the specific UE 100B may perform control to execute at least one of paging monitoring, cell selection, cell reselection, and measurement on the specific initial BWP without switching the specific initial BWP to the initial BWP (that is, the first initial BWP). In addition, in a case where a CD-SSB is present on the specific initial BWP, after the RA procedure fails, the specific UE 100B may perform the RA procedure again on the specific initial BWP without switching the specific initial BWP to the initial BWP (that is, the first initial BWP).

In the above-described embodiment, the mobile communication system based on NR has been described as an example of the mobile communication system 1. However, the mobile communication system 1 is not limited to this example. The mobile communication system 1 may be a system conforming to a TS of long term evolution (LTE) or another generation system (for example, a sixth generation) of the 3GPP standard. The base station 200 may be an eNB that provides evolved universal terrestrial radio access (E-UTRA) user plane and control plane protocol terminations towards the UE 100 in LTE. The mobile communication system 1 may be a system conforming to a TS defined in a standard other than the 3GPP standard. The base station 200 may be an integrated access and backhaul (IAB) donor or an IAB node.

In the above-described embodiment, the mobile communication system based on NR has been described as an example of the mobile communication system 1. However, the mobile communication system 1 is not limited to this example. The mobile communication system 1 may be a system conforming to a TS of LTE or another generation system (for example, a sixth generation) of the 3GPP standard. The base station 200 may be an eNB that provides E-UTRA user plane and control plane protocol terminations towards the UE 100 in LTE. The mobile communication system 1 may be a system conforming to a TS defined in a standard other than the 3GPP standard.

The steps in the operation of the above-described embodiment may not necessarily be performed in chronological order according to the order described in the flowchart or sequence diagram. For example, the steps in the operation may be performed in an order different from the order described in the flowchart or the sequence diagram, or may be performed in parallel. In addition, some of the steps in the operation may be removed or additional steps may be added to the process.

Furthermore, each operation flow described above needs not be necessarily implemented separately and independently, and two or more operation flows can be implemented in combination. For example, some steps of one operation flow may be added to another operation flow, or some steps of one operation flow may be replaced with some steps of another operation flow.

A program for causing a computer to execute each process performed by the UE 100 or the base station 200 may be provided. The program may be recorded in a computer readable medium. By using the computer readable medium, the program can be installed in the computer. Here, the computer readable medium in which the program is recorded may be a non-transitory recording medium. The non-transitory recording medium is not particularly limited, but may be, for example, a recording medium such as a compact disk read only memory (CD-ROM) or a digital versatile disc read only memory (DVD-ROM). Furthermore, a circuit that executes each process to be performed by the UE 100 or the base station 200 may be integrated, and at least a part of the UE 100 or the base station 200 may be configured as a semiconductor integrated circuit (a chipset or a system on chip (SoC)).

In the above-described embodiment, the term “transmit” may mean performing a process of at least one layer in a protocol stack used for transmission, or may mean physically transmitting a signal in a wireless or wired manner. Alternatively, the term “transmit” may mean a combination of performing a process of at least one layer in a protocol stack used for transmission and physically transmitting a signal in a wireless or wired manner. Similarly, the term “receive” may mean performing a process of at least one layer in a protocol stack used for reception, or may mean physically receiving a signal in a wireless or wired manner. Alternatively, the term “receive” may mean a combination of performing a process of at least one layer in a protocol stack used for reception and physically receiving a signal in a wireless or wired manner. Similarly, the term “obtain/acquire” may mean obtaining/acquiring information from stored information, may mean obtaining/acquiring information from information received from another node, or may mean obtaining/acquiring information by generating the information. Similarly, the term “based on” and “depending on/in response to” do not mean “only based on” or “only on depending/only in response to” unless explicitly stated otherwise. The term “based on” means both “only based on” and “at least partially based on”. Similarly, the term “depending on/in response to” means both “only depending on/in response to” and “at least partially depending on/in response to”. Similarly, the terms “include” and “comprise” do not mean including only enumerated items, but mean both including only enumerated items and including additional items in addition to the enumerated items. Similarly, in the present disclosure, the “or” does not mean exclusive OR but means OR. Moreover, any reference to elements using designations such as “first”, “second”, and the like used in the present disclosure does not generally limit the amount or order of those elements. These designations may be used in the present disclosure as a convenient method to distinguish between two or more elements. Therefore, references to first and second elements do not mean that only two elements can be employed therein or that the first element should precede the second element in any form. In the present disclosure, when articles such as a, an, and the in English are added by translation, these articles cover the plural meaning unless the context clearly indicates otherwise.

Although the present disclosure has been described in accordance with examples, it is understood that the present disclosure is not limited to the examples or structures. The present disclosure also covers various modified examples or modifications made within an equivalent range. In addition, various combinations or modes, or other combinations or modes including only one element, more elements, or less elements also fall within the scope and spirit of the present disclosure.

### (Supplementary Notes)

Features related to the above-described embodiment are additionally described.

### (Supplementary Note 1)

A communication apparatus (100, 100B) that is a second communication apparatus (100B) having a communication capability reduced as compared with a first communication apparatus (100A) having a designated communication capability, the communication apparatus including:

a controller (120) configured to perform a random access procedure using a specific initial BWP for the second communication apparatus (100B), which is a bandwidth part (BWP) that is a part of a bandwidth of a cell of a base station (200) in a radio resource control (RRC) idle state or an RRC inactive state, wherein

the controller (140) is configured to switch the specific initial BWP to an initial BWP in which a CD-SSB is present, when the random access procedure has failed, in a case where no cell defining-synchronization signal block and physical broadcast channel block (CD-SSB) is present on the specific initial BWP.

### (Supplementary Note 2)

The communication apparatus according to supplementary note 1, wherein

the random access procedure includes processing of transmitting a random access preamble to the base station (200) and processing of receiving a response to the random access preamble from the base station (200), and

the controller (140) is configured to switch the specific initial BWP to the initial BWP when the number of times the response is not received from the base station (200) as the failure of the random access procedure reaches a designated number of times.

### (Supplementary Note 3)

The communication apparatus according to supplementary note 1 or 2, wherein

the random access procedure includes processing of transmitting a request message for establishing an RRC connection or resuming the RRC connection to the base station (200) and processing of receiving a response to the request message from the base station (200), and

the controller (140) is configured to switch the specific initial BWP to the initial BWP when an RRC rejection message is received as the response from the base station (200).

### (Supplementary Note 4)

The communication apparatus according to any one of supplementary notes 1 to 3, further including:

a transmitter (122) configured to transmit a request message for establishing an RRC connection to the base station (200), wherein

the controller (140) is configured to switch the specific initial BWP to the initial BWP when a response to the request message is not received from the base station (200) within a designated time after the request message is transmitted.

### (Supplementary Note 5)

The communication apparatus according to any one of supplementary notes 1 to 4, further including:

a transmitter (122) configured to transmit a request message for resuming an RRC connection to the base station (200), wherein

the controller (140) is configured to switch the specific initial BWP to the initial BWP when a response to the request message is not received from the base station (200) within a designated time after the request message is transmitted.

### (Supplementary Note 6)

The communication apparatus according to any one of supplementary notes 1 to 5, further including:

a transmitter (111) configured to transmit a request message for resuming an RRC connection to the base station (200), wherein

the controller (140) is configured to switch the specific initial BWP to the initial BWP when an integrity check failure indication indicating a failure of an integrity check is transmitted to an RRC layer from a lower layer within a designated time after the request message is received.

### (Supplementary Note 7)

The communication apparatus according to any one of supplementary notes 1 to 6, wherein

the controller (140) is configured to perform control to execute at least one of paging monitoring, cell selection, cell reselection, and measurement on the specific initial BWP after the random access procedure fails in a case where a CD-SSB is present on the specific initial BWP.

### (Supplementary Note 8)

The communication apparatus according to any one of supplementary notes 1 to 7, wherein

the specific initial BWP is an initial BWP that is not used for communication between the first communication apparatus (100A) and the base station (200) but is used for communication between the second communication apparatus (100B) and the base station (200).

### (Supplementary Note 9)

The communication apparatus according to any one of supplementary notes 1 to 7, wherein

the specific initial BWP is an initial BWP used for communication between the first communication apparatus (100A) and the base station (200) and communication between the second communication apparatus (100B) and the base station (200).

### (Supplementary Note 10)

A communication apparatus (100, 100B) that is a second communication apparatus (100B) having a communication capability reduced as compared with a first communication apparatus (100A) having a designated communication capability, the communication apparatus including:

a controller (140) configured to perform a random access procedure using a specific initial BWP for the second communication apparatus (100B), which is a bandwidth part (BWP) that is a part of a bandwidth of a cell of a base station (200) in a radio resource control (RRC) idle state or an RRC inactive state; and

a transmitter (122) configured to transmit a request message for establishing an RRC connection or resuming the RRC connection to the base station (200) in the random access procedure, wherein

the controller (140) is configured to switch the specific initial BWP to an initial BWP when an RRC rejection message is received as a response to the request message from the base station (200) in a case where no cell defining-synchronization signal block and physical broadcast channel block (CD-SSB) is present on the specific initial BWP.

### (Supplementary Note 11)

A communication apparatus (100, 100B) that is a second communication apparatus (100B) having a communication capability reduced as compared with a first communication apparatus (100A) having a designated communication capability, the communication apparatus including:

a controller (140) configured to perform a random access procedure using a specific initial BWP for the second communication apparatus (100B), which is a bandwidth part (BWP) that is a part of a bandwidth of a cell of a base station (200) in a radio resource control (RRC) idle state or an RRC inactive state; and

a transmitter (122) configured to transmit a request message for establishing an RRC connection or resuming the RRC connection to the base station (200) in the random access procedure, wherein

the controller (140) is configured to switch the specific initial BWP to an initial BWP, when a response to the request message is not received from the base station (200) within a designated time after the request message is transmitted, in a case where no cell defining-synchronization signal block and physical broadcast channel block (CD-SSB) is present on the specific initial BWP.

### (Supplementary Note 12)

A communication apparatus (100, 100B) that is a second communication apparatus (100B) having a communication capability reduced as compared with a first communication apparatus (100A) having a designated communication capability, the communication apparatus including:

a controller (140) configured to perform a random access procedure using a specific initial BWP for the second communication apparatus (100B), which is a bandwidth part (BWP) that is a part of a bandwidth of a cell of a base station (200) in a radio resource control (RRC) idle state or an RRC inactive state; and

a transmitter (122) configured to transmit a request message for resuming an RRC connection to the base station (200) in the random access procedure, wherein

the controller (140) is configured to switch the specific initial BWP to an initial BWP, when an integrity check failure indication indicating a failure of an integrity check is transmitted to an RRC layer from a lower layer within a designated time after the request message is received, in a case where no cell defining-synchronization signal block and physical broadcast channel block (CD-SSB) is present on the specific initial BWP.

### (Supplementary Note 13)

The communication apparatus according to any one of supplementary notes 1 to 12, wherein

the designated communication capability is a capability based on at least one of a maximum bandwidth used for radio communication and the number of receivers, and

the second communication apparatus is at least one of an apparatus having a narrower maximum bandwidth than the first communication apparatus and an apparatus having a smaller number of receivers than the first communication apparatus.

### (Supplementary Note 14)

The communication apparatus according to any one of supplementary notes 1 to 13, wherein

the second communication apparatus is a reduced capability new radio device in a 5th generation system of a 3rd generation partnership project standard.

### (Supplementary Note 15)

A communication method executed by a communication apparatus (100, 100B) that is a second communication apparatus (100B) having a communication capability reduced as compared with a first communication apparatus (100A) having a designated communication capability, the communication method including the steps of:

performing a random access procedure using a specific initial BWP for the second communication apparatus (100B), which is a bandwidth part (BWP) that is a part of a bandwidth of a cell of a base station (200) in a radio resource control (RRC) idle state or an RRC inactive state; and

switching the specific initial BWP to an initial BWP in which a CD-SSB is present, when the random access procedure has failed, in a case where no cell defining-synchronization signal block and physical broadcast channel block (CD-SSB) is present on the specific initial BWP.

1. A communication apparatus comprising:
a receiver configured to receive, from a base station, information for configuring a first initial downlink bandwidth part (BWP) and information for configuring a second initial downlink BWP;
a controller configured to perform a random access procedure on the second initial downlink BWP; and
a transmitter configured to transmit, to the base station, a request message for resuming an radio resource control (RRC) connection, wherein
the controller is configured to:
start a timer on a basis of the transmission of the request message for resuming the RRC connection; and
control to operate on the first initial downlink BWP on which a cell defining-synchronization signal and physical broadcast channel block (CD-SSB) is transmitted, in a case where an RRC layer receives an integrity check failure indication for indicating a failure of an integrity check from a lower layer while the timer is running.

2. The communication apparatus according to claim 1, wherein
the controller is configured to control to operate on the first initial downlink BWP in a case where the CD-SSB is not transmitted on the second initial downlink BWP.

3. The communication apparatus according to claim 1, wherein
the controller is configured to control to perform at least one of monitoring of downlink control information for a paging, a cell selection, a cell re-selection, and a measurement for the cell selection, and a measurement for the cell re-selection, on the first initial downlink BWP, as the operation.

4. The communication apparatus according to claim 1, wherein
the information for configuring the first initial downlink BWP and the information for configuring the second initial downlink BWP are included in system information.

5. The communication apparatus according to claim 1, wherein
the communication apparatus is in an RRC idle state or an RRC inactive state.

6. A communication method performed by a communication apparatus, the communication method comprising the steps of:
receiving, from a base station, information for configuring a first initial downlink bandwidth part (BWP) and information for configuring a second initial downlink BWP;
performing a random access procedure on the second initial downlink BWP;
transmitting, to the base station, a request message for resuming a radio resource control (RRC) connection;
starting a timer on a basis of the transmission of the request message for resuming the RRC connection; and
controlling to operate on the first initial downlink BWP on which a cell defining-synchronization signal and physical broadcast channel block (CD-SSB) is transmitted, in a case where an RRC layer receives an integrity check failure indication for indicating a failure of an integrity check from a lower layer to while the timer is running.

7. The communication method according to claim 6, wherein
the controlling to operate on the first initial downlink BWP is performed in a case where the CD-SSB is not transmitted on the second initial downlink BWP.

8. The communication method according to claim 6, wherein
at least one of monitoring of downlink control information for a paging, a cell selection, a cell re-selection, and a measurement for the cell selection, and a measurement for the cell re-selection, is performed on the first initial downlink BWP as the operation.

9. The communication method according to claim 6, wherein
the information for configuring the first initial downlink BWP and the information for configuring the second initial downlink BWP are included in system information.

10. The communication method according to claim 6, wherein
the communication apparatus is in an RRC idle state or an RRC inactive state.
